(19) United States
(12) Patent Application Publication
(10) Pub. No.: US 2019/0355104 A1
(43) Pub. Date: Nov. 21, 2019

(54) Image Correction Method and Apparatus

(71) Applicant: Huawei Technologies Co., Ltd., Shenzhen (CN)

(72) Inventors: Yunchao Zhang, Beijing (CN); Wenmei Gao, Beijing (CN)

(21) Appl. No.: 16/338,364

(22) PCT Filed: Sep. 29, 2016
(86) PCT No.: PCT/CN2016/100953

§ 371 Date: Mar. 29, 2019

(51) Int. Cl. G06T 5/00; G06T 7/20; G06T 7/62; G06T 7/00

(52) U.S. Cl. CPC G06T 5/006; G06T 7/20; G06T 2207/10016; G06T 7/97; G06T 7/62

(57) ABSTRACT

Embodiments of the present invention relate to the field of image processing, and provide an image correction method and apparatus, to implement image correction with short time and light load, and improve real-time performance of image sequence correction. A solution provided in the embodiments of the present invention includes: capturing an i^{th} frame of image, where i is a positive integer greater than or equal to 1; tracking a quadrilateral area of an initial frame of image in the i^{th} frame of image by using an optical flow constraint equation, to obtain a quadrilateral area of the i^{th} frame of image; and correcting the i^{th} frame of image based on the quadrilateral area of the i^{th} frame of image. The present invention is applied to image correction.

### TECHNICAL FIELD

The present invention relates to the field of image processing, and in particular, to an image correction method and apparatus.

### BACKGROUND

Conventional scanners convert, by scanning by using optoelectronic processing technologies and digital processing technologies, static image information (for example, paper files and drawing papers) into digital signals for displaying, editing, storing, and the like of computers.

With development and popularization of mobile Internet and intelligent terminals, intelligent terminals with built-in cameras gradually replace conventional scanners and become a preferred manner of obtaining electronic data due to convenience and ease of performing sharing at any time and any place of the intelligent terminals. The intelligent terminals replace the scanners, so that not only conventional static image information can be recorded, but also dynamic image information, such as slideshows, lecture notes, and television pictures, that cannot be placed into the scanners and that includes image sequences can be recorded at any time.

However, during image capturing, limitations of a photographing angle and a lighting condition are inevitable, causing projection distortion of and a non-target area in a captured image. To resolve the problem, currently, a common processing solution is to correct the captured image by using algorithms such as quadrangle detection and trapezoid correction. In the quadrangle detection algorithm, an edge extraction algorithm in computer vision is used to detect rectangular edges of a target image, so as to remove a non-target area outside of a rectangular frame. Projection correction is performed, by using the trapezoid correction algorithm, on a rectangular area obtained by using the quadrangle detection algorithm, so that projection distortion caused by a photographing angle is corrected, and a target image having relatively high quality is obtained.

Currently, in a solution of correcting dynamic image information including an image sequence, quadrangle detection and trapezoid correction are usually performed on each frame of image included in the dynamic image information. When the dynamic image information includes a relatively large quantity of frames of images, a correction process takes excessively long time, system load is relatively heavy, and real-time performance is poor.

### SUMMARY

Embodiments of the present invention provide an image correction method and apparatus, to implement image correction with short time and light load, and improve real-time performance of image sequence correction.

To achieve the foregoing objective, the following technical solutions are used in the embodiments of the present invention.

According to a first aspect of this application, an image correction method is provided. The method may be applied to an image capturing terminal. The method specifically includes: step 1: capturing an i^{th} frame of image, where i is a positive integer greater than or equal to 1; step 2: tracking a quadrilateral area of an initial frame of image in the i^{th} frame of image by using an optical flow constraint equation, to obtain a quadrilateral area of the i^{th} frame of image; and step 3: correcting the i^{th} frame of image based on the quadrilateral area of the i^{th} frame of image.

In the image correction method provided in this application, an image in an image sequence is tracked by using the optical flow constraint equation before being corrected. Time of tracking using the optical flow constraint equation is one third shorter than that of using quadrangle detection. Therefore, by using the image correction method provided in this application, time of a process of correcting an image in an image sequence is greatly reduced. In this way, not only real-time performance of image correction is improved, but also processing efficiency of a device is improved and load of the device is reduced.

The quadrilateral area of the initial frame of image may be a pre-defined fixed area, or may be a quadrilateral area obtained by performing quadrangle detection on the initial frame.

With reference to the first aspect, in a possible implementation, an implementation solution of correcting the i^{th} frame of image based on the quadrilateral area of the i^{th} frame of image is provided, specifically including: calculating, based on the quadrilateral area of the i^{th} frame of image, an attitude transformation matrix Hᵢ₋₁ⁱ between the i^{th} frame of image and an (i−1)^{th} frame of image in an image sequence in which the i^{th} frame of image is located; calculating an estimated attitude transformation matrix H_{w}ⁱ=Hᵢ₋₁ⁱ×Hⁱ⁻¹ from the i^{th} frame of image to a real rectangle, where Hⁱ⁻¹ is an attitude transformation matrix from the (i−1)^{th} frame of image to the real rectangle; and correcting the i^{th} frame of image by using H_{w}ⁱ. When image correction is performed, an attitude transformation matrix from a current image to a real rectangle is estimated based on an attitude transformation matrix from a previous frame of image to the real rectangle, so that a problem of jitter between different frames of images due to user jitter or light adjustment is avoided, thereby improving stability during image sequence correction.

With reference to the first aspect or any foregoing possible implementation, in another possible implementation, an implementation solution of correcting the i^{th} frame of image based on the quadrilateral area of the i^{th} frame of image is provided, specifically including: calculating an actual attitude transformation matrix H_{c}ⁱ from the quadrilateral area of the i^{th} frame of image to a real rectangular area based on a geometrical relationship of side lengths of a quadrangle, and correcting the i^{th} frame of image by using H_{c}ⁱ. When image correction is performed, an attitude transformation matrix from a current image to a real rectangle is directly estimated. In this way, implementation is simple, and a process amount when another frame is corrected does not need to be stored, thereby avoiding occupation of content by the process amount.

With reference to the first aspect or any foregoing possible implementation, in another possible implementation, to improve implementation flexibility of the solution, the initial frame of image may be determined based on an actual requirement. Optionally, the initial frame of image may be a first frame of image in the image sequence in which the i^{th} frame of image is located.

With reference to the first aspect or any foregoing possible implementation, in another possible implementation, after the correcting the i^{th} frame of image based on the quadrilateral area of the i^{th} frame of image, the image correction method provided in this application may further include: if the i^{th} frame satisfies a reinitialization condition, updating the initial frame of image to an (i+1)^{th} frame in the image sequence. By using the reinitialization condition, a cumulative error of an optical flow tracking method is corrected, thereby improving robustness of an image correction process.

It should be noted that the reinitialization condition may be defined based on an actual requirement, and is not specifically limited in this application.

With reference to the first aspect or any foregoing possible implementation, in another possible implementation, the reinitialization condition is defined by using a frame-quantity difference between a current frame of image and the initial frame of image, and it is determined in terms of a time dimension whether to perform reinitialization. The reinitialization condition may include: a frame-quantity difference between the current frame of image and the initial frame is greater than or equal to a first preset threshold.

Further, optionally, it is determined in terms of a time dimension whether to perform reinitialization, and the reinitialization condition may alternatively include: a time difference between a current time point and a time point at which the initial frame is corrected is greater than or equal to a preset threshold.

With reference to the first aspect or any foregoing possible implementation, in another possible implementation, the reinitialization condition is defined by using a quantity of tracking points of the current frame of image, and it is determined in terms of tracking quality whether to perform reinitialization, so that a reinitialization occasion better satisfies a correction precision requirement. The reinitialization condition may include: a quantity of tracking points for tracking the quadrilateral area of the initial frame by using the optical flow constraint equation is less than or equal to a second preset threshold.

It should be noted that each of the foregoing preset thresholds may be set based on an actual requirement, and is not specifically limited in this application.

With reference to the first aspect or any foregoing possible implementation, in another possible implementation, if it is set in the image correction method to perform reinitialization when the reinitialization condition is satisfied, after the capturing an i^{th} frame of image, the image correction method provided in this application may further include: determining whether the i^{th} frame of image is the initial frame of image; and if the i^{th} frame of image is not the initial frame of image, performing the step 2 and the step 3 to correct the i^{th} frame of image. In this way, different types of correction processing are performed on an initial frame of image and a non-initial frame of image.

With reference to the first aspect or any foregoing possible implementation, in another possible implementation, after the determining whether the i^{th} frame of image is the initial frame of image, if the i^{th} frame of image is the initial frame of image, the i^{th} frame of image is corrected by using a method for correcting an initial frame of image, which may specifically include: performing quadrangle detection on the i^{th} frame of image, to obtain a quadrilateral area of the i^{th} frame of image, calculating an actual attitude transformation matrix H from the quadrilateral area of the i^{th} frame of image to a real rectangular area, and correcting the i^{th} frame of image by using H:

With reference to the first aspect or any foregoing possible implementation, in another possible implementation, after the determining whether the i^{th} frame of image is the initial frame of image, if the i^{th} frame of image is an initial frame of image, the i^{th} frame of image is corrected by using a method for correcting an initial frame of image, which may specifically include: performing the step 2 and the step 3 first to correct the i^{th} frame of image, and then performing quadrangle detection on the i^{th} frame of image, to obtain the quadrilateral area of the i^{th} frame of image as the quadrilateral area of the initial frame.

With reference to the first aspect or any foregoing possible implementation, in another possible implementation, to make an image correction process easy for implementation, may include an estimated attitude transformation matrix H_{w}ⁱ⁻¹ from the (i−1)^{th} frame of image to the real rectangle.

With reference to the first aspect or any foregoing possible implementation, in another possible implementation, to make an image correction result more accurate, may include an actual attitude transformation matrix H_{c}ⁱ⁻¹ from the (i−1)^{th} frame of image to the real rectangle.

With reference to the first aspect or any foregoing possible implementation, in another possible implementation, the tracking a quadrilateral area of an initial frame of image in the i^{th} frame of image by using an optical flow constraint equation, to obtain a quadrilateral area of the i^{th} frame of image may be specifically implemented as: tracking, in the i^{th} frame of image, a location of each stable corner point in a stable-point set by using the optical flow constraint equation, to obtain the quadrilateral area of the i^{th} frame of image, where the stable-point set includes at least four stable corner points in the quadrilateral area of the initial frame of image.

With reference to the first aspect or any foregoing possible implementation, in another possible implementation, after the correcting the i^{th} frame of image based on the quadrilateral area of the i^{th} frame of image, the image correction method provided in this application may further include: presenting the corrected i^{th} frame of image to a user. In this way, real-time correction and output to a user are implemented.

With reference to the first aspect or any foregoing possible implementation, in another possible implementation, after the correcting the i^{th} frame of image based on the quadrilateral area of the i^{th} frame of image, the image correction method provided in this application may further include: when i is equal to N, consecutively presenting the corrected first frame of image to a corrected N^{th} frame of image in the image sequence to a user, where N is greater than or equal to 2, and the image sequence includes N frames of images. In this way, the image sequence is uniformly output to a user after being corrected frame by frame.

According to a second aspect, an embodiment of the present invention provides an image correction apparatus. The image correction apparatus may implement functions in the foregoing method embodiment. The functions may be implemented by hardware, or may be implemented by hardware executing corresponding software. The hardware or software includes one or more modules corresponding to the foregoing functions.

With reference to the second aspect, in a possible implementation, a structure of the image correction apparatus includes a processor and a transceiver. The processor is configured to support the image correction apparatus to perform corresponding functions in the foregoing method. The transceiver is configured to support communication between the image correction apparatus and another device. The image correction apparatus may further include a memory. The memory is configured to be coupled to the processor, and stores a necessary program instruction and necessary data of the image correction apparatus.

According to a third aspect, an embodiment of the present invention provides a computer storage medium, configured to store a computer software instruction that is used by the image correction apparatus and that includes a program designed to perform the foregoing aspects.

The solutions provided in the second aspect and the third aspect are used to implement the image correction method provided in the first aspect, and therefore can achieve same beneficial effects as that of the first aspect. Details are not described herein again.

### BRIEF DESCRIPTION OF DRAWINGS

To describe the technical solutions in the embodiments of the present invention more clearly, the following briefly describes the accompanying drawings required for describing the embodiments or the prior art. Apparently, the accompanying drawings in the following descriptions show merely some embodiments of the present invention, and a person of ordinary skill in the art may still derive other drawings from these accompanying drawings without creative efforts.

FIG. 1 is a schematic diagram of an application scenario of an image correction method according to an embodiment of the present invention;

FIG. 2 is a schematic structural diagram of an image correction apparatus according to an embodiment of the present invention;

FIG. 3 is a schematic flowchart of an image correction method according to an embodiment of the present invention;

FIG. 3A is a schematic diagram of a tracking result using an optical flow constraint equation according to an embodiment of the present invention;

FIG. 4 is a schematic flowchart of a method for correcting an i^{th} frame of image according to a quadrilateral area of the i^{th} frame of image according to an embodiment of the present invention;

FIG. 4A is a schematic diagram of an image correction process according to an embodiment of the present invention;

FIG. 5 is a schematic flowchart of another image correction method according to an embodiment of the present invention:

FIG. 5A is a schematic diagram of an image correction result according to an embodiment of the present invention;

FIG. 6 is a schematic structural diagram of another image correction apparatus according to an embodiment of the present invention; and

FIG. 7 is a schematic structural diagram of still another image correction apparatus according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

In addition, the term “and/or” in this specification describes only an association relationship between associated objects and represents that three relationships may exist. For example, A and/or B may represent the following three cases: Only A exists, both A and B exist, and only B exists. In addition, the character “/” in this specification generally indicates an “or” relationship between the associated objects.

Before the embodiments of the present invention are described, an application environment of image correction is first described.

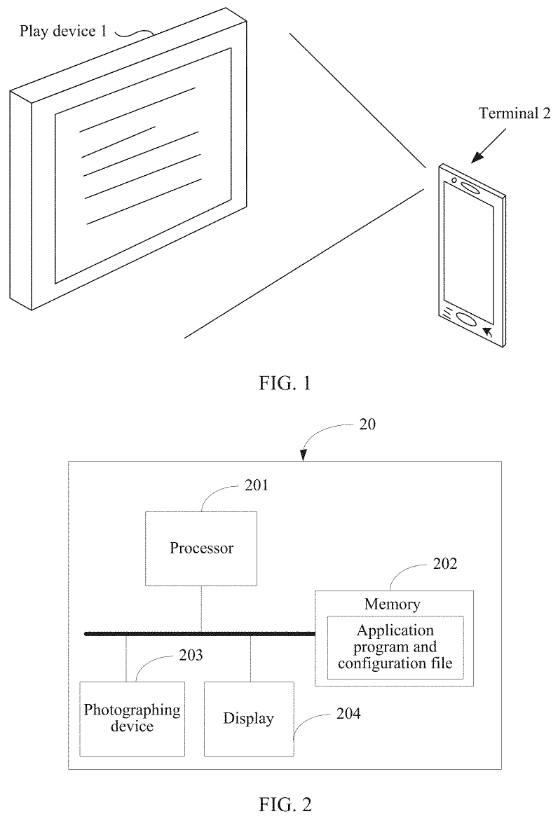

As shown in FIG. 1, FIG. 1 schematically shows an application environment of image correction. The application environment includes a play device 1 for playing a dynamic picture, and a terminal 2 configured to capture the dynamic picture played by the play device 1 and obtain an image sequence.

Specifically, the terminal 2 invokes a built-in photographing apparatus to photograph the dynamic picture played by the play device 1. A size of the picture photographed by the terminal 2 is usually larger than that of the original dynamic picture, and an oblique angle exists. The terminal 2 invokes a built-in image correction apparatus to correct the photographed picture in real time, and outputs and presents the photographed original dynamic picture to a user in a form of a short-video or dynamic image after the photographed original dynamic picture is corrected.

The play device 1 may be a device, such as a television or a projector, that is configured to play a dynamic picture. A type of the play device 1 is not specifically limited in this embodiment of the present invention.

The terminal 2 may be user equipment (English full name: User Equipment, UE), a mobile phone, a tablet computer, a notebook computer, an ultra-mobile personal computer (English full name: Ultra-mobile Personal Computer, UMPC), a netbook, a personal digital assistant (English full name: Personal Digital Assistant. PDA), an ebook, a mobile television, a wearable device, or the like. A type of the terminal 2 is not specifically limited in this embodiment of the present invention either.

Based on the above, the basic principle of the present invention is: an image correction apparatus built in a terminal performs quadrangle detection on an initial frame in a captured image sequence, to obtain a quadrilateral area for correction. The quadrilateral area of the initial frame is tracked in other frames than the initial frame by using an optical flow constraint, and a quadrilateral area is corrected after being obtained. Because the optical flow tracking method takes short time, real-time performance of an entire correction process is greatly improved, and load of the terminal is reduced.

FIG. 2 is a schematic structural diagram of an image correction apparatus 20 related to the embodiments of the present invention. The image correction apparatus 20 is built in the terminal 2 in the application scenario shown in FIG. 1, and may be a part of the terminal 2 or may be the entire terminal 2.

As shown in FIG. 2, the image correction apparatus 20 may include: a processor 201, a memory 202, a photographing device 203, and a display 204.

Components of the image correction apparatus 20 are described in detail below with reference to FIG. 2.

The memory 202 may be a volatile memory (English full name: volatile memory), for example, a random access memory (English full name: random-access memory, RAM), or a non-volatile memory (English full name: non-volatile memory), for example, a read-only memory (English full name: read-only memory, ROM), a flash memory (English full name: flash memory), a hard disk (English full name: hard disk drive, HDD), or a solid-state drive (English full name: solid-state drive, SSD), or a combination of the foregoing types of memories, and is configured to store a related application program and a configuration file that can implement a method in the present invention.

The processor 201 is a control center of the image correction apparatus 20, and may be a central processing unit (English full name: central processing unit, CPU) or an application-specific integrated circuit (English full name: Application Specific Integrated Circuit, ASIC), or may be configured to be one or more integrated circuits for implementing the embodiments of the present invention, for example, one or more microprocessors (English full name: digital signal processor, DSP) or one or more field programmable gate arrays (English full name: Field Programmable Gate Array, FPGA). The processor 201 may run or execute a software program and/or a module stored in the memory 202 and invoke data stored in the memory 202, to perform various functions of the image correction apparatus 20.

The photographing device 203 may be a camera or another device, and is configured to capture an image sequence including at least one frame of image.

The display 204 may be a user interaction interface, and is configured to present a corrected image to a user.

The embodiments of the present invention are clarified in detail below with reference to the accompanying drawings.

Nouns used in the embodiments of the present invention are explained first as follows:

Quadrilateral area: a location at which a file, a video picture, a slideshow, or a lecture note is located in a captured image, that is, an area enclosed by outer edges. In consideration of a photographing angle, the area is usually an irregular quadrangle. The quadrilateral area is usually obtained by detecting a photographed image using an edge detection algorithm in computer vision.

Rectangular area: a length and a width of a file, a video picture, a slideshow, or a lecture note in a captured image in the real world. The area is usually a regular rectangle. Generally, an actual length and width of the area cannot be directly measured. Therefore, an algorithm is required for estimating an actual length-width ratio of the rectangular area.

Attitude: different forms of a file, a video picture, a slideshow, or a lecture note in a captured image, which is a relative concept. An attitude includes a conversion process from one form to another form, and may be represented in mathematics by using a homography matrix that is referred to as an attitude transformation matrix.

When quadrilateral areas of two images are obtained, an attitude transformation matrix between the two images may be obtained through calculation.

Conversion represented by an attitude transformation matrix from an image to a real rectangle is performed on a quadrangle of the image based on the attitude transformation matrix from the image to the real rectangle, so that the image can be corrected.

For example, image capture is an attitude changing process from a rectangular area to a quadrilateral area, and a homography matrix from a rectangle to a quadrangle is referred to as a quadrangle transformation attitude. Similarly, a process of the image moving from a location in a first frame of image to a location in a second frame of image is another attitude changing process, and may also be represented by using an attitude transformation matrix that is referred to as an attitude transformation matrix between the first frame of image and the second frame of image.

According to one aspect, an embodiment of the present invention provides an image correction method, applied to the image correction apparatus 20 shown in FIG. 2 and the application scenario shown in FIG. 1.

It should be noted that in the image correction method provided in this embodiment of the present invention, processes of correcting frames in an image sequence are the same. Only a process of correcting an i^{th} frame of image in an image sequence is described below in this embodiment of the present invention, and details are not described one by one.

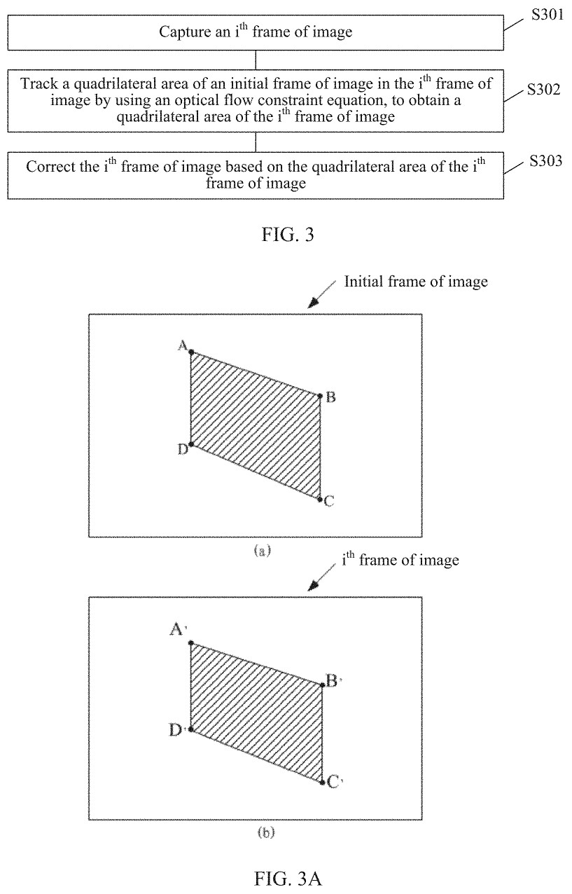

As shown in FIG. 3, the method may include the following steps.

S301: Capture the i^{th} frame of image.

Specifically, S301 is performed by the photographing device 203 included in the image correction apparatus 20 shown in FIG. 2.

i is a positive integer greater than or equal to 1.

S302: Track a quadrilateral area of an initial frame of image in the i^{th} frame of image by using an optical flow constraint equation, to obtain a quadrilateral area of the i^{th} frame of image.

Specifically, S302 is performed by the processor 201 included in the image correction apparatus 20 shown in FIG. 2.

Optionally, in a possible implementation, the quadrilateral area of the initial frame of image may be a pre-defined fixed quadrilateral area. In this implementation, in the image correction apparatus 20, a static mode may be used to correspond to a fixed quadrilateral area. When a user chooses the static mode of the apparatus 20, it is determined that a pre-defined fixed quadrilateral area in an image correction process is the fixed quadrilateral area corresponding to the static mode.

Different modes may be preset in the apparatus 20 to correspond to different quadrilateral areas, and the user chooses different modes to determine a fixed quadrilateral area. This is not specifically limited in this embodiment of the present invention.

Optionally, the quadrilateral area of the initial frame of image may be obtained by performing quadrangle detection on the initial frame of image. Correspondingly, before S302, quadrangle detection has been performed on the initial frame of image, and the quadrilateral area of the initial frame of image has been obtained.

Optionally, the initial frame of image may be a frame of image in a debugging phase before the image sequence is captured, or may be a first frame of image in the image sequence. Certainly, the initial frame of image may alternatively be set based on an actual requirement. The initial frame of image is not specifically limited in this embodiment of the present invention.

For example, a quadrangle detection process may include: performing Gaussian down-sampling on an image; if an input image is a colorful image, converting the input image into a grayscale image: reducing noise of the image by using a filtering algorithm; performing edge detection by using an operator; performing straight-line screening on a detected edge by means of Hough transform; and constructing an appropriate quadrangle by using a screened straight line.

The filtering algorithm may include, but is not limited to, Gaussian filtering, median filtering, and bilateral filtering. The operator for edge detection may include, but is not limited to, a Canny operator and a Sobel operator.

It should be noted that the quadrangle detection process is not specifically limited to the foregoing example.

Specifically, in S302, the tracking a quadrilateral area of an initial frame of image in the i^{th} frame of image by using an optical flow constraint equation, to obtain a quadrilateral area of the i^{th} frame of image may be implemented as: tracking, in the i^{th} frame of image, a location of each stable corner point in a stable-point set by using the optical flow constraint equation, to obtain the quadrilateral area of the i^{th} frame of image.

The stable-point set includes at least four stable corner points in the quadrilateral area of the initial frame of image. The stable-point set includes, but is not limited to, four vertexes of the quadrilateral area of the initial frame of image.

The optical flow constraint equation is used to reflect a motion of a pixel point in three-dimensional space to a motion vector in a two-dimensional imaging plane, and a specific location of the pixel point in a next frame can be solved based on an optical flow equation conservation law: A specific process is not described in detail in this embodiment of the present invention.

For example, as shown in (a) of FIG. 3A, the quadrilateral area of the initial frame of image obtained by performing quadrangle detection on the initial frame of image is shown by a shadow area in the figure. The area is a quadrilateral area whose four vertexes are respectively A, B, C, and D.

In S302, in the i^{th} frame of image, the quadrilateral area of the initial frame of image shown in FIG. 3A is tracked by using the optical flow constraint equation, and the stable-point set for tracking is set to A, B, C, and D in the quadrilateral area of the initial frame of image. Assuming that locations of A, B, C, and D tracked in the i^{th} frame of image by using the optical flow constraint equation are respectively A′, B′, C′, and D′, the quadrilateral area of the i^{th} frame is shown by a shadow area in (b) of FIG. 3A.

S303: Correct the i^{th} frame of image based on the quadrilateral area of the i^{th} frame of image.

Specifically, S303 is performed by the processor 201 included in the image correction apparatus 20 shown in FIG. 2.

Optionally, the correcting the i^{th} frame of image based on the quadrilateral area of the i^{th} frame of image in S303 may be specifically implemented by using any of the following two solutions.

First Solution:

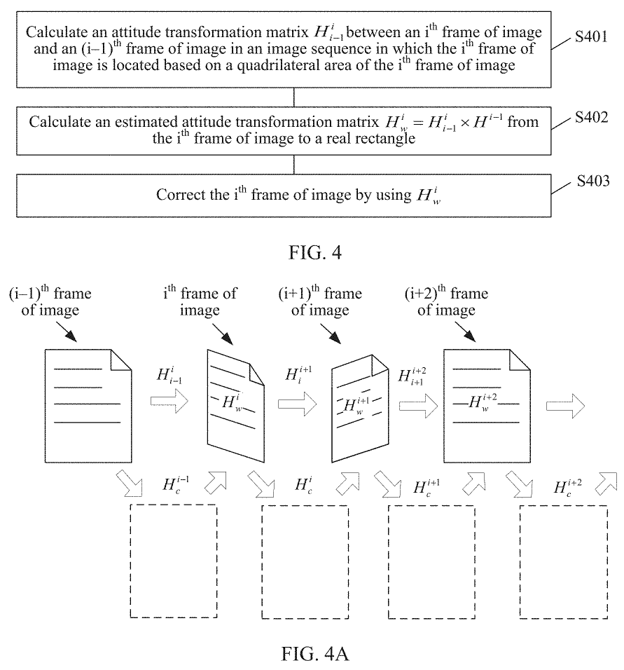

In the first solution, as shown in FIG. 4, a process of the correcting the i^{th} frame of image based on the quadrilateral area of the i^{th} frame of image may specifically include S401 to S403.

S401: Calculate an attitude transformation matrix Hᵢ₋₁ⁱ between the i^{th} frame of image and an (i−1)^{th} frame of image in the image sequence in which the i^{th} frame of image is located based on the quadrilateral area of the i^{th} frame of image.

A homography matrix in mathematics from the quadrilateral area of the (i−1)^{th} frame of image to the quadrilateral area of the i^{th} frame of image is calculated as the attitude transformation matrix between the i^{th} frame of image and the (i−1)^{th} frame of image in the image sequence in which the i^{th} frame of image is located.

S402: Calculate an estimated attitude transformation matrix H_{w}ⁱ=Hᵢ₋₁ⁱ×Hⁱ⁻¹ from the i^{th} frame of image to a real rectangle.

Hⁱ⁻¹ is an attitude transformation matrix from the (i−1)^{th} frame of image to the real rectangle.

Optionally, Hⁱ⁻¹ may include an estimated attitude transformation matrix H_{w}ⁱ⁻¹ from the (i−1)^{th} frame of image to the real rectangle or an actual attitude transformation matrix H_{c}ⁱ⁻¹ from the (i−1)^{th} frame of image to the real rectangle.

It should be noted that whether specific content of Hⁱ⁻¹ is H_{w}ⁱ⁻¹ or H_{c}ⁱ⁻¹ may be set based on an actual requirement. This is not specifically limited in this embodiment of the present invention.

S403: Correct the i^{th} frame of image by using H_{w}ⁱ.

Specifically, a conversion process represented by H_{w}ⁱ is performed on the quadrilateral area of the i^{th} frame of image to complete correction of the i^{th} frame of image.

Further, if Hⁱ⁻¹ in S402 is H_{c}ⁱ⁻¹, after S403, the method may further include: calculating an actual attitude transformation matrix H_{c}ⁱ from the i^{th} frame of image to the real rectangle based on the quadrilateral area of the i^{th} frame of image and the corrected i^{th} frame of image, so as to calculate H_{w}ⁱ⁺¹ when S402 is performed for correcting an (i+1)^{th} frame of image.

For example, as shown in FIG. 4A. FIG. 4A schematically shows a process of correcting, by using the first solution, an image sequence including a plurality of frames of images. Hⁱ⁻¹ is H_{c}ⁱ⁻¹.

Specifically, in the process shown in FIG. 4A, when an i^{th} frame of image is corrected, an estimated attitude transformation matrix H_{w}ⁱ from the i^{th} frame of image to a real rectangle is obtained by using an attitude transformation matrix Hᵢ₋₁ⁱ between the i^{th} frame of image and a previous frame of image and an actual attitude transformation matrix H_{c}ⁱ⁻¹ from the previous frame of image to the real rectangle, to correct the i^{th} frame of image, and an actual attitude transformation matrix H_{c}ⁱ from the i^{th} frame of image to the real rectangle is calculated to correct an (i+1) frame of image.

Further, when the (i+1)^{th} frame of image is corrected, an estimated attitude transformation matrix H_{w}ⁱ⁺¹ from the (i+1)^{th} frame of image to the real rectangle is obtained by using an attitude transformation matrix Hᵢⁱ⁺¹ between the (i+1) frame of image and the previous frame of image and an actual attitude transformation matrix H_{c}ⁱ from the previous frame of image to the real rectangle, to correct the (i+1)^{th} frame of image, and an actual attitude transformation matrix H_{c}ⁱ⁺¹ from the (i+1)^{th} frame of image to the real rectangle is calculated to correct an (i+2)^{th} frame of image.

Further, when the (i+2)^{th} frame of image is corrected, an estimated attitude transformation matrix H_{w}ⁱ⁺² from the (i+2)^{th} frame of image to the real rectangle is obtained by using an attitude transformation matrix Hᵢ₊₁ⁱ⁺² between the (i+2)^{th} frame of image and the previous frame of image and an actual attitude transformation matrix H_{c}ⁱ⁺¹ from the previous frame of image to the real rectangle, to correct the (i+2)^{th} frame of image, and an actual attitude transformation matrix H_{c}ⁱ⁺² from the (i+2)^{th} frame of image to the real rectangle is calculated to correct an (i+3)^{th} frame of image. For subsequent iterative processing, details are not described herein.

Second Solution:

In the second solution, a process of the correcting the i^{th} frame of image based on the quadrilateral area of the i^{th} frame of image may specifically include: first calculating a length-width ratio of an original rectangular area based on a geometrical relationship of side lengths of a quadrangle and the quadrilateral area of the i^{th} frame of image; then calculating an attitude transformation matrix from the quadrilateral area of the i^{th} frame of image to the original rectangle; and at last, correcting the quadrilateral area of the i^{th} frame of image based on the attitude transformation matrix from the quadrilateral area of the i^{th} frame of image to the original rectangle.

It should be noted that only the process of correcting the i^{th} frame of image is described in S301 to S303. When a frame of image is obtained, the process of S301 to S303 is performed for correction, and details are not described one by one in this embodiment of the present invention.

In the image correction method provided in this embodiment of the present invention, an image in an image sequence is tracked by using the optical flow constraint equation before being corrected. Time of tracking using the optical flow constraint equation is one third shorter than that of using quadrangle detection. Therefore, by using the image correction method provided in this application, time of a process of correcting an image in an image sequence is greatly reduced. In this way, not only real-time performance of image correction is improved, but also processing efficiency of a device is improved and load of the device is reduced.

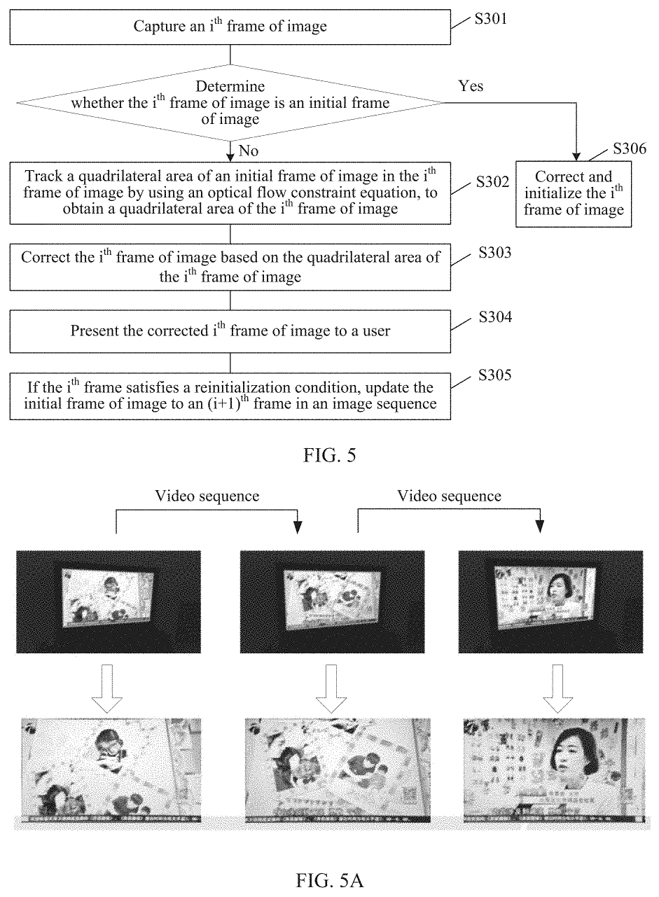

Optionally, as shown in FIG. 5, after S303, the method may further include S304.

S304: Present the corrected i^{th} frame of image to a user.

Specifically, S304 is performed by the processor 201 included in the image correction apparatus 20 shown in FIG. 2 by using the display 204.

Optionally, the corrected i^{th} frame of image may be immediately presented to the user after S303.

Optionally, after S303, if i is equal to N, where N is greater than or equal to 2, and the image sequence includes N frames of images, S304 may be specifically implemented as: consecutively presenting the corrected first frame of image to a corrected N^{th} frame of image in the image sequence to the user.

Optionally, when S304 is performed, the corrected first frame of image to the corrected N^{th} frame of image in the image sequence may be consecutively presented to the user in a form of video or dynamic image.

Further, the initial frame of image may be updated in the correction process. As shown in FIG. 5, after S303, the method may further include S305.

S305: If the i^{th} frame satisfies a reinitialization condition, update the initial frame of image to an (i+1)^{th} frame in the image sequence.

Specifically; S305 is performed by the processor 201 included in the image correction apparatus 20 shown in FIG. 2.

Optionally, the reinitialization condition may include: a frame-quantity difference between the i^{th} frame and the initial frame is greater than or equal to a first preset threshold; or a quantity of tracking points for tracking the quadrilateral area of the initial frame by using the optical flow constraint equation is less than or equal to a second preset threshold; or duration to a time point at which the initial frame id corrected is greater than or equal to a third preset threshold.

A value of the first preset threshold, the second preset threshold, or the third preset threshold may be set based on an actual requirement. This is not specifically limited in this embodiment of the present invention. A smaller specified value of the first preset threshold, the second preset threshold, or the third preset threshold indicates higher accuracy of image correction, but real-time performance is correspondingly reduced. A larger specified value of the first preset threshold, the second preset threshold, or the third preset threshold indicates higher real-time performance of image correction, but accuracy is correspondingly reduced.

It should be noted that the reinitialization condition may be set based on an actual requirement. This is not specifically limited in this embodiment of the present invention.

Further, as shown in FIG. 5, after S301, the method may further include the following step:

S301a: Determine whether the i^{th} frame of image is the initial frame of image.

Specifically, S301a is performed by the processor 201 included in the image correction apparatus 20 shown in FIG. 2.

Specifically, if the i^{th} frame of image is not the initial frame of image, S302 and S303 are performed to correct the i^{th} frame of image.

Further, after S301a, if the i^{th} frame of image is the initial frame of image, the method may further include the following step:

S306: Correct and initialize the i^{th} frame of image.

Specifically, S306 is performed by the processor 201 included in the image correction apparatus 20 shown in FIG. 2.

Optionally, S306 may be implemented by using any of the following two solutions.

Solution A:

Quadrangle detection is performed on the i^{th} frame of image to obtain a quadrilateral area of the i^{th} frame of image, an actual attitude transformation matrix H_{c}ⁱ from the quadrilateral area of the i^{th} frame of image to a real rectangular area is calculated, and the i^{th} frame of image is corrected by using H_{c}ⁱ.

It should be noted that a specific performing process of the solution A is the same as the quadrangle detection described in S302 and the second solution in S303, and details are not described herein again.

Solution B

S302 and S303 are first performed to correct the i^{th} frame of image, and then quadrangle detection is performed on the i^{th} frame of image, to obtain the quadrilateral area of the i^{th} frame of image as the quadrilateral area of the initial frame for optical flow tracking of a subsequent frame of image.

It should be noted that in the solution B, the performing S302 and S303 to correct the i^{th} frame of image and the performing quadrangle detection on the i^{th} frame of image to obtain the quadrilateral area of the i^{th} frame of image as the quadrilateral area of the initial frame may be performed at the same time or may be successively performed. This is not specifically limited in this embodiment of the present invention.

It should be further noted that a chronological performing order of the steps included in FIG. 5 is not specifically limited in this embodiment of the present invention. FIG. 5 only schematically shows a chronological performing order by way of example.

For example, a comparison between a captured video sequence including a plurality of frames of images before and after correction by using the image correction method provided in this embodiment of the present invention is schematically shown in FIG. 5A.

In FIG. 5A, the first row shows continuous frames of images in the video sequence before correction, and the second row shows images obtained by correcting the frames of images in the first row using the image correction method provided in this embodiment of the present invention.

The solution provided in the embodiments of the present invention is described above mainly from the perspective of a working process of an image correction apparatus. It may be understood that to implement the foregoing functions, the image correction apparatus includes corresponding hardware structures and/or software modules for performing the functions. A person skilled in the art should be easily aware that, examples of units and algorithm steps described with reference to the embodiments disclosed in this specification may be implemented in the present invention in a form of hardware or a form of a combination of hardware and computer software. Whether a function is performed by hardware or by computer software driving hardware depends on particular applications and design constraint conditions of the technical solutions. A skilled person may implement described functions for each particular application by using different methods, but it should not be considered that such implementation goes beyond the scope of the present invention.

In the embodiments of the present invention, the image correction apparatus may be divided into functional modules according to the foregoing method embodiment. For example, the functional modules may be divided corresponding to the functions, or two or more functions may be integrated into one processing module. The integrated module may be implemented in a form of hardware, or may be implemented in a form of a software functional module. It should be noted that the division of the modules in the embodiments of the present invention is an example and is merely division of logical functions. There may be other division manners during actual implementation.

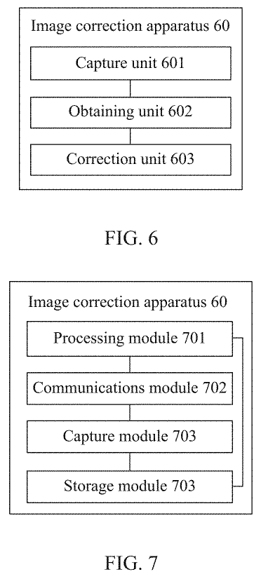

When the functional modules are divided corresponding to the functions, FIG. 6 is a possible schematic structural diagram of the image correction apparatus 60 in the foregoing embodiment. The image correction apparatus 60 includes: a capture unit 601, an obtaining unit 602, and a correction unit 603. The capture unit 601 is configured to support the image correction apparatus 60 to perform the process S301 in FIG. 3 or FIG. 5. The obtaining unit 602 is configured to support the image correction apparatus 60 to perform the process S302 in FIG. 3 or FIG. 5. The correction unit 603 is configured to support the image correction apparatus 60 to perform the process S303 in FIG. 3 or FIG. 5. All related content of the steps in the foregoing method embodiment may be quoted to descriptions of functions of corresponding functional modules, and details are not described herein again.

When an integrated unit is used, FIG. 7 is a possible schematic structural diagram of the image correction apparatus 60 in the foregoing embodiment. The image correction apparatus 60 may include: a processing module 701, a communications module 702, and a capture module 703. The processing module 701 is configured to perform control management on an action of the image correction apparatus 60. For example, the processing module 701 is configured to support the image correction apparatus 60 to perform the process S301 in FIG. 3 or FIG. 5 by using the capture module 703. The processing module 701 is further configured to support the image correction apparatus 60 to perform the process S302 and the process S303 in FIG. 3 or FIG. 5, and/or is configured to perform another process in the technology described in this specification. The communications module 702 is configured to support the image correction apparatus 60 to communicate with another network entity. The image correction apparatus 60 may further include a storage module 704, configured to store program code and data in the image correction apparatus 60.

The processing module 701 may be the processor 201 in the entity structure of the image correction apparatus 20 shown in FIG. 2, and may be a processor or a controller. For example, the processing module 701 may be a CPU, a general-purpose processor, a DSP, an ASIC, an FPGA or another programmable logic device, a transistor logic device, a hardware component, or any combination thereof. The processing module 701 may implement or execute examples of various logic blocks, modules, and circuits described with reference to content disclosed in the present invention. The processor 201 may alternatively be a combination for implementing a computing function, for example, a combination including one or more microprocessors or a combination of a DSP and a microprocessor. The communications module 702 may be a communications port, or may be a transceiver, a transceiver circuit, a communications interface, or the like. The capture module 703 may be the photographing device 203 in the entity structure of the image correction apparatus 20 shown in FIG. 2, and may be a camera or a camera module. The storage module 704 may be the memory 202 in the entity structure of the image correction apparatus 20 shown in FIG. 2.

When the processing module 701 is a processor, the capture module 703 is a photographing device, and the storage module 704 is a memory, the image correction apparatus 60 in FIG. 7 in the embodiments of the present invention may be the image correction apparatus 20 shown in FIG. 2.

Steps of the methods or algorithms described with reference to the content disclosed in the present invention may be implemented by hardware, or may be implemented by a processor executing a software instruction. The software instruction may be formed by a corresponding software module. The software module may be stored in a RAM, a flash memory, a ROM, an erasable programmable read-only memory (Erasable Programmable ROM, EPROM), an electrically erasable programmable read-only memory (Electrically EPROM, EEPROM), a register, a hard disk, a removable hard disk, a compact disc read-only memory (CD-ROM), or any other forms of storage media known in the art. An example of a storage medium is coupled to the processor, so that the processor can read information from the storage medium, and can write information into the storage medium. Certainly, the storage medium may alternatively be a component of the processor. The processor and the storage medium may be located in an ASIC. In addition, the ASIC may be located in a core-network interface device. Certainly, the processor and the storage medium may alternatively be stored, as a discrete assembly, in a core-network interface device.

It may be clearly understood by a person skilled in the art that, for convenient and brief description, for a detailed working process of the foregoing system, apparatus, and unit, refer to a corresponding process in the foregoing method embodiments, and details are not described herein again.

A person skilled in the art should be aware that in the foregoing one or more examples, functions described in the present invention may be implemented by using hardware, software, firmware, or any combination thereof. When being implemented by using software, the foregoing functions may be stored in a computer-readable medium or transmitted as one or more instructions or code in the computer-readable medium. The computer-readable medium includes a computer storage medium and a communications medium. The communications medium includes any medium that facilitates a computer program to be transmitted from one place to another. The storage medium may be any available medium accessible to a general-purpose or dedicated computer. It may be clearly understood by a person skilled in the art that, for convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and there may be other division manners during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, a network device, or the like) to perform some of the steps of the methods described in the embodiments of the present invention. The foregoing storage medium includes: any medium that can store program code, such as a USB flash drive, a removable hard disk, a read-only memory (Read-Only Memory, ROM for short), a random access memory (Random Access Memory, RAM for short), a magnetic disk, or an optical disc.

Finally, it should be noted that the foregoing embodiments are merely intended for describing the technical solutions of the present invention but not for limiting the present invention. Although the present invention is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of the embodiments of the present invention.

1. An image correction method, comprising:
capturing an i^{th} frame of an image, wherein i is a positive integer greater than or equal to 1;
tracking a quadrilateral area of an initial frame of the image in the i^{th} frame by using an optical flow constraint equation in order to obtain a quadrilateral area of the i^{th} frame; and
correcting the i^{th} frame based on the quadrilateral area of the i^{th} frame.

2. The method of claim 1, wherein correcting the i^{th} frame based on the quadrilateral area of the i^{th} frame comprises:
calculating, based on the quadrilateral area of the i^{th} frame, an attitude transformation matrix Hᵢ₋₁ⁱ between the i^{th} frame and an (i−1)^{th} frame of the image in an image sequence in which the i^{th} frame is located;
calculating an estimated attitude transformation matrix H_{w}ⁱ=Hᵢ₋₁ⁱ×Hⁱ⁻¹ from the i^{th} frame to a real rectangle, wherein Hⁱ⁻¹ is an attitude transformation matrix from the (i−1)^{th} frame to the real rectangle; and
correcting the i^{th} frame using H_{w}ⁱ.

3. The method of claim 1, wherein the initial frame is a first frame of the image in an image sequence in which the i^{th} frame is located.

4. The method of claim 1, wherein after correcting the i^{th} frame based on the quadrilateral area of the i^{th} frame, the method further comprises:
updating the initial frame to an (i+1)^{th} frame in an image sequence when the i^{th} frame satisfies a reinitialization condition.

5. The method of claim 4, wherein the reinitialization condition comprises:
a frame-quantity difference between the i^{th} frame and the initial frame is greater than or equal to a first preset threshold; or
a quantity of tracking points for tracking the quadrilateral area of the initial frame using the optical flow constraint equation is less than or equal to a second preset threshold.

6. The method of claim 1, wherein after capturing the i^{th} frame, the method further comprises:
determining whether the i^{th} frame is the initial frame; and
performing, when the i^{th} frame is not the initial frame, the tracking the quadrilateral area of the initial frame and correcting the i^{th} frame to correct the i^{th} frame.

7. The method of claim 6, wherein after determining whether the i^{th} frame is the initial frame, when the i^{th} frame is the initial frame, the method further comprises:
performing quadrangle detection on the i^{th} frame, in order to obtain a quadrilateral area of the i^{th} frame, calculating an actual attitude transformation matrix H_{c}ⁱ from the quadrilateral area of the i^{th} frame to a real rectangular area, and correcting the i^{th} frame by using H_{c}ⁱ; or
performing tracking the quadrilateral area of the initial frame and correcting the i^{th} frame first to correct the i^{th} frame, and then performing quadrangle detection on the i^{th} frame, in order to obtain the quadrilateral area of the i^{th} frame as the quadrilateral area of the initial frame.

8. The method of claim 2, wherein Hⁱ⁻¹ comprises:
an estimated attitude transformation matrix H_{w}ⁱ⁻¹ from the (i−1)^{th} frame to the real rectangle; or
an actual attitude transformation matrix H_{c}ⁱ⁻¹ from the (i−1)^{th} frame to the real rectangle.

9. The method of claim 1, wherein tracking the quadrilateral area of the initial frame in the i^{th} frame by using the optical flow constraint equation in order to obtain the quadrilateral area of the i^{th} frame comprises tracking, in the i^{th} frame, a location of each stable corner point in a stable-point set by using the optical flow constraint equation in order to obtain the quadrilateral area of the i^{th} frame, wherein the stable-point set comprises at least four stable corner points in the quadrilateral area of the initial frame.

10. The method of claim 1, wherein after correcting the i^{th} frame based on the quadrilateral area of the i^{th} frame, the method further comprises:
presenting the corrected i^{th} frame to a user; or
consecutively presenting, when i is equal to N, the corrected first frame to a corrected N^{th} frame of the image in an image sequence to a user, wherein N is greater than or equal to 2, and wherein the image sequence comprises N frames of images.

11. An image correction apparatus, comprising
a memory storing executable instructions; and
a processor coupled to the memory and configured to:
capture an i^{th} frame of an image, wherein i is a positive integer greater than or equal to 1;
track a quadrilateral area of an initial frame of the image in the i^{th} frame using an optical flow constraint equation in order to obtain a quadrilateral area of the i^{th} frame; and
correct the i^{th} frame based on the quadrilateral area of the i^{th} frame.

12. The image correction apparatus of claim 11, wherein the processor is further configured to:
calculate, based on the quadrilateral area of the i^{th} frame, an attitude transformation matrix Hᵢ₋₁ⁱ between the i^{th} frame and an (i−1)^{th} frame of the image in an image sequence in which the i^{th} frame is located;
calculate an estimated attitude transformation matrix H_{w}ⁱ=Hᵢ₋₁ⁱ×Hⁱ⁻¹ from the i^{th} frame to a real rectangle, wherein Hⁱ⁻¹ is an attitude transformation matrix from the (i−1)^{th} frame to the real rectangle; and
correct the i^{th} frame of by using H_{w}ⁱ.

13. The image correction apparatus of claim 11, wherein the initial frame is a first frame of the image in an image sequence in which the i^{th} frame is located.

14. The image correction apparatus of claim 11, wherein the processor is further configured to update the initial frame to an (i+1)^{th} frame in an image sequence after correcting the i^{th} frame based on the quadrilateral area of the i^{th} frame, when the i^{th} frame satisfies a reinitialization condition.

15. The image correction apparatus of claim 14, wherein the reinitialization condition comprises:
a frame-quantity difference between the i^{th} h frame and the initial frame is greater than or equal to a first preset threshold; or
a quantity of tracking points for tracking the quadrilateral area of the initial frame by using the optical flow constraint equation is less than or equal to a second preset threshold.

16. The image correction apparatus of claim 11, wherein the processor is further configured to:
determine whether the i^{th} frame is the initial frame after the capturing the i^{th} frame; and
perform, when the i^{th} frame is not the initial frame, tracking the quadrilateral area of the initial frame and correcting the i^{th} frame to correct the i^{th} frame.

17. The image correction apparatus of claim 16, wherein after determining whether the i^{th} frame is the initial frame, when the i^{th} frame is the initial frame, the processor is further configured to:
perform quadrangle detection on the i^{th} frame in order to obtain a quadrilateral area of the i^{th} frame, calculate an actual attitude transformation matrix H_{c}ⁱ from the quadrilateral area of the i^{th} frame to a real rectangular area, and correct the i^{th} frame using H_{c}ⁱ; or
perform tracking the quadrilateral area of the initial frame and correcting the i^{th} frame first to correct the i^{th} frame, and then perform quadrangle detection on the i^{th} frame in order to obtain the quadrilateral area of the i^{th} frame as the quadrilateral area of the initial frame.

18. The image correction apparatus of claim 12, wherein Hⁱ⁻¹ comprises:
an estimated attitude transformation matrix H_{w}ⁱ⁻¹ from the (i−1) frame to a real rectangle; or
an actual attitude transformation matrix H_{c}ⁱ⁻¹ from the (i−1)^{th} frame to the real rectangle.

19. The image correction apparatus of claim 11, wherein the processor is further configured to track, in the i^{th} frame, a location of each stable corner point in a stable-point set using the optical flow constraint equation in order to obtain the quadrilateral area of the i^{th} frame, wherein the stable-point set comprises at least four stable corner points in the quadrilateral area of the initial frame.

20. The image correction apparatus of claim 11, wherein after correcting the i^{th} frame based on the quadrilateral area of the i^{th} frame, the processor is further configured to:
present the corrected i^{th} frame to a user; or
consecutively present, when i is equal to N, the corrected first frame to a corrected N^{th} frame of the image in an image sequence to a user, wherein N is greater than or equal to 2, and wherein the image sequence comprises N frames of images.
